(19) United States
(12) Patent Application Publication
(10) Pub. No.: US 2020/0321821 A1
(43) Pub. Date: Oct. 8, 2020

(54) CORONA SHIELD, ELECTRIC MACHINE, AND METHOD FOR MANUFACTURING THE CORONA SHIELD

(71) Applicant: Siemens Aktiengesellschaft, Munich (DE)

(72) Inventors: Mario Brockschmidt, Essen (DE); Christopher Eckert, Essen (DE); Manuel Ettler, Nörvenich-Wissersheim (DE); Vera Kristin Franke, Essen (DE); Rene Höhner, Gelsenkirchen (DE); Andrey Mashkin, Köln (DE); Friedhelm Pohlmann, Essen (DE); Guido Schmidt, Leichlingen (DE); Ralph Seybold, Spardorf (DE); Christian Staubach, Marl (DE)

(73) Assignee: Siemens Aktiengesellschaft, Munich (DE)

(21) Appl. No.: 16/303,839

(22) PCT Filed: Apr. 21, 2017
(86) PCT No.: PCT/EP2017/059487

§ 371 Date: Nov. 21, 2018

(30) Foreign Application Priority Data
May 23, 2016 (EP) 16170822.7

(51) Int. Cl. H02K 3/40; H02K 3/30; H01B 1/24; C09D 5/24; C09D 7/40; C09D 7/65; C09D 4/06

(52) U.S. Cl. CPC H02K 3/40; H02K 3/30; H01B 1/24; C09D 4/06; C09D 7/70; C09D 7/65; C09D 5/24

(57) ABSTRACT

A corona shield for an electric machine, has a varnish that contains a first polymer resin, first electrically conductive particles that are dispersed in the first polymer resin, and microcapsules which are dispersed in the first polymer resin and include a second polymer resin in their interior.

### CROSS REFERENCE TO RELATED APPLICATIONS

This application is the US National Stage of International Application No. PCT/EP2017/059487 filed Apr. 21, 2017, and claims the benefit thereof. The International Application claims the benefit of European Application No. EP16170822 filed May 23, 2016. All of the applications are incorporated by reference herein in their entirety.

### FIELD OF INVENTION

The invention relates to a corona shield and to an electrical machine comprising the corona shield.

### BACKGROUND OF INVENTION

An electrical machine, for example a turbogenerator in a power plant for generation of electrical energy, is subject to high mechanical, thermal and electrical stress. In particular, the turbogenerator has a laminated core and a winding of electrical conductors. The laminated core has a multitude of grooves in which the conductors are accommodated. At the two ends of the laminated core, the electrical conductors protrude from the laminated core. The conductors are insulated by a main insulation that electrically insulates the conductors from one another, from the laminated core and from the environment.

For avoidance of partial discharges, a corona shield is disposed on the surface of the main insulation facing away from the conductor. For avoidance of partial discharges at the interface between the main insulation and the laminated core, the corona shield has, between the main insulation and the laminated core, a weakly electrically conductive and grounded outer corona shield that may protrude from the laminated core. For grounding, the outer corona shield has electrically conductive connection to the laminated core. The outer corona shield homogenizes the electrical field emanating from the electrical conductor. It is thus possible to avoid regions with local excess electrical field strength, which means that the formation of partial discharges at the surface of the main insulation is also prevented.

In addition, the corona shield has an end corona shield provided at the axial end of the outer corona shield at the interface between the main insulation and the environment. The end corona shield is weakly electrically conductive and may also have a resistance progression that decreases in a linear manner with increasing distance from the outer corona shield. The end corona shield is set up to dissipate the electrical field formed in the operation of the turbogenerator in a direction away from the laminated core.

Damage to the outer corona shield that can occur, for example, in the placing of the electrical conductor encased with the main insulation and the outer corona shield into the groove or in the insertion of side ripple springs between the outer corona shield and the laminated core impairs the electrical field-homogenizing effect of the outer corona shield and can lead to excess electrical field strength and hence to partial discharges. The partial discharges lead to breakdown of the main insulation and the outer corona protection and hence shorten the lifetime of the electrical machine. Damage to the end corona shield can impair the electrical field-dissipating effect of the end corona shield and hence contribute to the formation of partial discharges in the region of the end corona shield.

### SUMMARY OF INVENTION

It is therefore an object of the invention to provide a corona shield for an electrical machine, wherein the corona shield can be used to prolong the lifetime of the electrical machine.

The corona shield of the invention for an electrical machine includes a varnish including a first polymer resin, first electrically conductive particles dispersed in the first polymer resin and microcapsules dispersed in the first polymer resin, a second polymer resin being included within said microcapsules. In the event of damage to the corona shield of the invention, the microcapsules burst in the damaged region, which results in flow of the second polymer resin present in the microcapsules into the damaged region, where it cures. As a result, the corona shield can repair itself, which means that the corona shield and hence also the electrical machine have a long lifetime. The first electrically conductive particles cause the corona shield to be electrically conductive. If the first electrically conductive particles remain in the damaged region of the corona shield, the electrically conductive particles bring about weak electrical conductivity in the repaired corona shield. It is advantageous that the first polymer resin and the second polymer resin are the same. It is advantageous that the corona shield is an outer corona shield and/or an end corona shield.

It is advantageous that the varnish includes second electrically conductive particles disposed within the microcapsules. As a result, in the event of damage to the corona shield, the second electrically conductive particles also flow into the damaged region. This achieves the effect that the damaged region is electrically conductive after the curing of the second polymer resin, such that an electrical field emanating from an electrical conductor of the electrical machine is also homogenized in the area of the damaged region and around this region. This advantageously prevents field strength excesses, which means that it is possible to avoid partial discharges in the region of the electrical machine. It is advantageous that the proportion by mass of the microcapsules based on the varnish and the proportion by mass of the second particles relative to the varnish is chosen at such a level that the second particles are in overpercolating form in the cured region. This means that the second particles form a continuous network in the cured region that connects boundary points of the cured region to one another, which means that the damaged region is electrically conductive overall after the second polymer resin has cured. It is advantageous here that the first electrically conductive particles and/or the second electrically conductive particles include graphite, carbon black and/or inorganic particles having an electrically conductive coating.

It is advantageous that the sum total of the proportions by weight of the microcapsules and the first electrically conductive particles, based on the varnish, is from 5% to 90%. The addition of the microcapsules increases the viscosity of the varnish. However, a low viscosity is advantageous for the processing of the varnish. Within the specified range of values for the proportion by weight, the varnish has sufficiently low viscosity for processing and a sufficiently high proportion by weight of the microcapsules to achieve good healing of the damaged region. The weight ratio of the microcapsules to the first electrically conductive particles is advantageously from 1 to 10, especially from 1 to 2.

It is advantageous that the polymer resin is a copolymer. It is advantageous here that the copolymer is a polymer based on polyacrylate, especially acrylic ester and/or acrylonitrile, and/or polystyrene. It is further advantageous that a portion of the microcapsules includes only one of the monomers of the copolymer and another portion of the microcapsules includes only another of the monomers of the copolymer. As a result, the two monomers advantageously do not come into contact until the microcapsules burst in the event of damage, which means that curing can only occur after the damage.

Electrically nonconductive inorganic nanoparticles are advantageously included within the microcapsules; the nanoparticles especially include TiO₂, SiO₂, Al₂O₃ and/or MgO. If partial discharges nevertheless occur in and/or in the vicinity of the damaged region after the damaged region has cured, the region cured with the nanoparticles has a higher resistance to the partial discharges and hence a longer lifetime than would be the case without the nanoparticles.

A solvent is advantageously included within the microcapsules, especially ethanol, n-propanol, isopropanol, ethyl acetate and/or an alkane, especially n-pentane, n-hexane and/or n-heptane. This can reduce the viscosity of the liquid present in the microcapsules, i.e. the polymer resin with the solvent, which means that the liquid can be finely distributed within the damaged region after the bursting of the microcapsules and can penetrate even into very small cracks. In this way, virtually complete repair of the damaged region is possible. Moreover, evaporation of the solvent can also result in curing of the polymer resin.

It is advantageous that the wall material of the microcapsules includes wax, polyurea-formaldehyde and/or polyurethane. The microcapsules advantageously have an average diameter of 10 μm to 1500 μm.

It is advantageous that the microcapsules have a wall thickness of 50 nm to 500 nm. By virtue of this wall thickness, the microcapsules have sufficient strength, such that they do not burst in the normal processing of the varnish, but the wall thickness is simultaneously such that they burst in the event of damage to the corona shield.

The corona shield advantageously includes a porous tape impregnated by the varnish. The tape imparts elevated mechanical strength to the corona shield. The tape impregnated by the varnish advantageously has sufficient porosity to be processed in a VPI (vacuum pressure impregnation) process, meaning that the porosity is sufficiently high that the tape impregnated by the varnish can be impregnated by a resin, especially an epoxy resin. Advantageously, the tape is partly porous after performance of the VPI process, such that the capillary action of the tape allows the polymer resin present in the microcapsules to be distributed particularly efficiently within the tape in the event of damage to the microcapsules. Partial porosity can be achieved, for example, by means of hollow fibers in the tape. The partial porosity allows the corona shield to heal particularly efficiently and without the formation of air pockets that promote the formation of partial discharges. It is advantageous that the tape includes a weave and/or a nonwoven; the nonwoven and/or the weave especially includes polyethylene terephthalate (PET), polyester, glass, polyimide, polyaramid, polyamide, polypropylene and/or PTFE.

The electrical machine of the invention has an electrical conductor, a main insulation that encases the electrical conductor, and the corona shield applied to the outside of the main insulation. The corona shield may be an outer corona shield and/or an end corona shield.

The process of the invention for producing the corona shield has the steps of: —applying a varnish including a first polymer resin, first electrically conductive particles dispersed in the first polymer resin and microcapsules dispersed in the first polymer resin, a second polymer resin being included within said microcapsules, to a main insulation that encases an electrical conductor; —curing the polymer resin. It is possible here either to apply the varnish directly to the main insulation and cure it or first to apply the varnish to the tape and cure it on the tape, allowing the tape with the cured varnish to be applied subsequently to the main insulation. It is advantageous that the varnish includes a solvent, especially ethanol, n-propanol, isopropanol, ethyl acetate and/or an alkane, especially n-pentane, n-hexane and/or n-heptane, outside and within the microcapsules and the polymer resin is cured by evaporating the solvent present outside the microcapsules.

### BRIEF DESCRIPTION OF THE DRAWINGS

There follows a detailed elucidation of the invention with reference to the schematic drawings appended. The figures show:

FIG. 1 a corona shield of the invention prior to damage,

FIG. 2 the corona shield after damage and

FIGS. 3 and 4 the process of healing the damage.

### DETAILED DESCRIPTION OF INVENTION

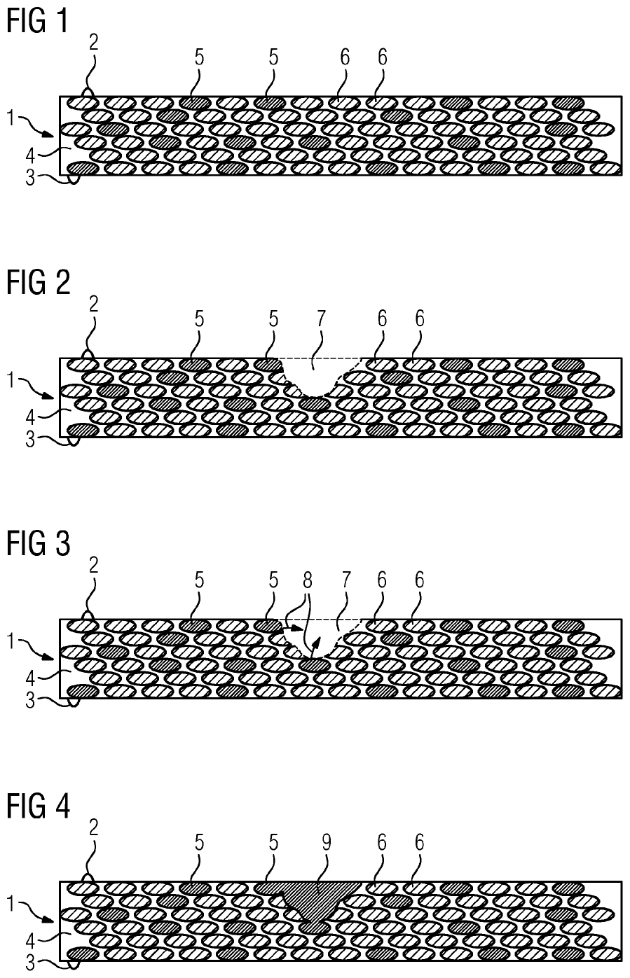

As apparent from FIGS. 1 to 4, a corona shield 1, for example an outer corona shield and/or an end corona shield, for an electrical machine includes a varnish 4. The varnish 4 includes a first polymer resin, first electrically conductive particles 6 dispersed in the first polymer resin and microcapsules 5 dispersed in the first polymer resin. A second polymer resin is included within the microcapsules 5. It is conceivable that the varnish includes an inorganic and electrically nonconductive filler, for example in the form of nanoparticles, where the filler is dispersed in the first polymer resin and/or second polymer resin. The filler allows the resistance of the corona shield 1 to partial discharges to be increased.

The microcapsules 5 may be produced, for example, in a dropletization process or by emulsion polymerization. The wall material of the microcapsules 5 may include wax, polyurea-formaldehyde and/or polyurethane. The microcapsules 5 may have an average diameter of 10 μm to 1500 μm. The microcapsules 5 may have a wall thickness of 50 nm to 3500 nm.

The varnish 4 may include second electrically conductive particles disposed within the microcapsules 5. The second electrically conductive particles may be the same as the first electrically conductive particles 6 in terms of their chemical composition and their size. It is also conceivable that the second electrically conductive particles are the same as the first electrically conductive particles 6 in terms of their chemical composition, but have a smaller average diameter than the first electrically conductive particles 6. It is thus possible for the second electrically conductive particles to be more easily accommodated in the microcapsules 5. For example, the first electrically conductive particles and/or the second electrically conductive particles may include graphite, carbon black and/or inorganic particles having an electrically conductive coating. It is conceivable that the electrical conductivity of the second particles is higher than the electrical conductivity of the first particles. This can achieve the effect that the electrical conductivity of the cured damaged regions, in spite of a lower particle concentration, is just as high as before the damage.

The sum total of the proportions by weight of the microcapsules 5 and the first semiconductor particles 6 based on the varnish 4 is, for example, from 10% to 50%. The weight ratio of the microcapsules 5 to the first electrically conductive particles is, for example, from 1 to 10, especially from 1 to 2.

For example, the first polymer resin and/or the second polymer resin are a copolymer. The copolymer may, for example, be a polymer based on polyacrylate, especially acrylic ester and/or acrylonitrile, and/or polystyrene. It is conceivable that a portion of the microcapsules 5 includes only one of the monomers of the copolymer and another portion of the microcapsules 5 only another of the monomers of the copolymer. This achieves the effect that the two monomers come into contact only in the event of bursting of the microcapsules 5, and the second polymer resin can cure.

In another example, the second polymer resin may include a monomer disposed only within a portion of the microcapsules 5. A polymerization initiator may be disposed within another portion of the microcapsules 5. The polymerization initiator may be dissolved in a solvent. This achieves the effect that the polymerization initiator and the monomer come into contact only in the event of bursting of the microcapsules 5, and hence the second polymer resin cures.

The varnish 4 may include a reactive diluent, for example 3-ethyloxetane-3-methanol or cycloaliphatic epoxides. The reactive diluents may have been mixed with the first polymer resin and/or with the second polymer resin.

Electrically nonconductive inorganic nanoparticles may additionally be included within the microcapsules 5. For example, the nanoparticles may include TiO₂, SiO₂, Al₂O₃ and/or MgO or consist of the aforementioned substances. A solvent may also be included within the microcapsules 5, especially ethanol, n-propanol, isopropanol, ethyl acetate and/or an alkane, especially n-pentane, n-hexane and/or n-heptane.

It is conceivable that the corona shield 1 includes a porous, electrically nonconductive tape impregnated by the varnish 4. The tape may include a weave and/or a nonwoven. The weave and/or the nonwoven may include hollow fibres. The weave and/or the nonwoven may include polyethylene terephthalate (PET), polyester, glass, polyimide, polyaramid, polyamide, polypropylene and/or PTFE.

FIGS. 1 to 4 show how the corona shield of the invention in the electrical machine self-heals. The electrical machine includes an electrical conductor, a main insulation that encases the electrical conductor, and the corona shield 1. The corona shield 1 has a radial outer face 2 and a radial inner face 3. The corona shield 1 has been applied to the radial outer face of the main insulation, such that the radial inner face 3 adjoins the radial outer face of the main insulation. The radial outer face 2 of the corona shield 1 is in touch contact with a laminated core of the electrical machine and can be damaged by this touch contact, by outside action and/or by partial discharges, which gives rise, as shown in FIG. 2, to a damaged region 7.

The damage results in bursting of the microcapsules 5 and flow of the second polymer resin present within them into the damaged region 7, as illustrated by the arrows 8 in FIG. 3. After the second polymer resin has cured, the damaged region 7 is filled and hence healed, as shown by the reference numeral 9 in FIG. 4.

Even though the invention has been illustrated in detail and described by the preferred working examples, the invention is not restricted by the examples disclosed, and other variations may be inferred therefrom by the person skilled in the art without leaving the scope of protection of the invention.

1. A corona shield for an electrical machine, comprising:
a varnish including a first polymer resin, first electrically conductive particles dispersed in the first polymer resin and microcapsules dispersed in the first polymer resin, a second polymer resin being included within said microcapsules, wherein the varnish includes second electrically conductive particles disposed within the microcapsules.

2. The corona shield as claimed in claim 1,
wherein the first electrically conductive particles and/or the second electrically conductive particles include graphite and/or carbon black.

3. The corona shield as claimed in claim 1,
wherein the sum total of the proportions by weight of the microcapsules and the first electrically conductive particles, based on the varnish, is from 5% to 90%.

4. The corona shield as claimed in claim 1,
wherein the weight ratio of the microcapsules to the first electrically conductive particles is from 1 to 10, especially from 1 to 2.

5. The corona shield as claimed in claim 1,
wherein the first polymer resin and/or second polymer resin is a copolymer.

6. The corona shield as claimed in claim 5,
wherein a portion of the microcapsules includes only one of the monomers of the copolymer and another portion of the microcapsules only another of the monomers of the copolymer.

7. The corona shield as claimed in claim 1,
wherein electrically nonconductive inorganic nanoparticles are included within the microcapsules.

8. The corona shield as claimed in claim 1,
wherein a solvent is included within the microcapsules.

9. The corona shield as claimed in claim 1,
wherein the wall material of the microcapsules includes wax, polyurea-formaldehyde and/or polyurethane.

10. The corona shield as claimed in claim 1,
wherein the microcapsules have an average diameter of 10 μm to 1500 μm.

11. The corona shield as claimed in claim 1,
wherein the corona shield has a porous, electrically nonconductive tape impregnated by the varnish.

12. An electrical machine comprising:
an electrical conductor,
a main insulation that encases the electrical conductor, and
a corona shield as claimed in claim 1 applied to the outside of the main insulation.

13. A process for producing a corona shield as claimed claim 1, comprising:
applying a varnish including a first polymer resin, first electrically conductive particles dispersed in the first polymer resin and microcapsules dispersed in the first polymer resin, a second polymer resin being included within said microcapsules, to a main insulation that encases an electrical conductor; and
curing the first polymer resin.

14. The process as claimed in claim 13,
wherein the varnish includes a solvent outside and within the microcapsules and the polymer resin is cured by evaporating the solvent present outside the microcapsules.

15. The corona shield as claimed in claim 4,
wherein the weight ratio of the microcapsules to the first electrically conductive particles is from 1 to 2.

16. The corona shield as claimed in claim 5,
wherein the copolymer is a polymer based on polyacrylate, acrylic ester, acrylonitrile, and/or polystyrene, and
wherein the first polymer resin and the second polymer resin are the same.

17. The corona shield as claimed in claim 7,
wherein the nanoparticles include TiO₂, SiO₂, Al₂O₃ and/or MgO.

18. The corona shield as claimed in claim 8,
wherein the solvent included within the microcapsules comprises ethanol, n-propanol, isopropanol, ethyl acetate, an alkane, n-pentane, n-hexane, and/or n-heptane.

19. The corona shield as claimed in claim 10,
wherein the microcapsules have a wall thickness of 50 nm to 3500 nm.

20. The corona shield as claimed in claim 11,
wherein the tape includes a weave and/or a nonwoven, and
wherein the weave and/or the nonwoven includes polyethylene terephthalate, polyester, glass, polyimide, polyaramid, polyamide, polypropylene, and/or PTFE.
